(19) United States
(12) Patent Application Publication
(10) Pub. No.: US 2025/0199140 A1
(43) Pub. Date: Jun. 19, 2025

(54) SIGNAL PROCESSING METHOD AND DEVICE FOR PHOTO DETECTOR

(71) Applicant: SOLIDVUE, INC., Gyeonggi-do (KR)

(72) Inventor: Hyeong Seok SEO, Gyeonggi-do (KR)

(73) Assignee: SOLIDVUE, INC., Gyeonggi-do (KR)

(21) Appl. No.: 18/393,795

(22) Filed: Dec. 22, 2023

(30) Foreign Application Priority Data
Dec. 19, 2023 (KR) 10-2023-0186190

(51) Int. Cl. G01S 7/4865; G01S 7/481; G01S 7/487; G01S 17/10; G01S 17/931

(52) U.S. Cl. CPC G01S 7/4865; G01S 7/4817; G01S 7/4873; G01S 17/10; G01S 17/931

(57) ABSTRACT

A signal processing method and device for a light receiving device are disclosed. The signal processing device cumulatively records, in a search memory, a number of echo laser reception times for N time slots (N is a natural number of 2 or more), selects at least one time slot in which the number of echo laser receptions reaches a candidate threshold as a candidate time slot, divides the candidate time slot into M detailed time slots (M is a natural number of 2 or more), cumulatively records, in a candidate memory, the number of echo laser receptions for each detailed time slot, and determines a reception time of an echo laser based on the number of echo laser receptions for each detailed time slot accumulated in the candidate memory.

### CROSS-REFERENCE TO RELATED APPLICATION

This application is based on and claims priority under 35 U.S.C. § 119 to Korean Patent Application No. 10-2023-0186190, filed on Dec. 19, 2023, in the Korean Intellectual Property Office, the disclosure of which is incorporated by reference herein in its entirety.

### BACKGROUND

### 1. Field

The disclosure relates to a method and device for processing signals from a light-receiving device, and more particularly, to a signal processing method and device for a time-to-digital converter (TDC) of a light receiving device used to measure a time of flight (TOF) in a light detection and ranging (LiDAR) sensor or image sensor.

### 2. Description of the Related Art

FIG. 1 is a diagram showing an example of a conventional LiDAR. A LIDAR 100 outputs a laser signal in the form of a pulse using a light emitting device, such as a vertical cavity surface emitting laser (VCSEL)/edge emitting laser diode (EELD). A light receiving device 120 detects the laser (hereinafter referred to as an echo laser) reflected from an object 130 and returned to the light receiving device 120. An example of the light receiving device 120 is a single photon avalanche diode (SPAD). The LiDAR 100 determines the distance to the object 130 by measuring the time (i.e., a time of flight (TOF)) in which the laser output from the light emitting device is reflected by the object 130 and returns to the light receiving device 120.

In order to increase the resolution (angular resolution) of the LiDAR 100, the resolution of the pixel that detects light in the light receiving device 120 must be increased. FIG. 2 is a diagram showing an example of an arrangement structure of a light receiving device and a TDC of the LiDAR. Referring to FIG. 2, a TDC element 210 is present in each column of a pixel array 200. Therefore, to increase the pixel resolution, it is necessary to reduce not only the pixel size, but also the size of the TDC 210.

### SUMMARY

Provided is a signal processing method and device that not only increase the resolution of a light-receiving device by reducing a size of a histogram memory used in signal processing for a TOF measurement, but also has almost no performance degradation even if the size of the light-receiving device is reduced.

Additional aspects will be set forth in part in the description which follows and, in part, will be apparent from the description, or may be learned by practice of the presented embodiments of the disclosure.

According to an aspect of the disclosure, an example of a signal processing method for a light receiving device includes cumulatively recording, in a search memory, a number of echo laser reception times for N time slots (N is a natural number of 2 or more); selecting at least one time slot in which the number of echo laser receptions reaches a candidate threshold as a candidate time slot; dividing the candidate time slot into M detailed time slots (M is a natural number of 2 or more) and cumulatively recording, in a candidate memory, the number of echo laser receptions for each detailed time slot; and determining a reception time of an echo laser based on the number of echo laser receptions for each detailed time slot accumulated in the candidate memory.

According to another aspect of the disclosure, a signal processing device for a light receiving device includes a search memory whereon a number of echo laser receptions is cumulatively recorded for N (N is a natural number of 2 or more) time slots; and a candidate memory whereon a number of receptions of the echo laser for at least one time slot in which the number of receptions corresponds to a predefined candidate threshold is cumulatively recorded, wherein the search memory and the candidate memory each include a histogram memory including a plurality of bins including a plurality of bits.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram showing an example of a conventional LiDAR;

FIG. 2 is a diagram showing an example of an arrangement structure of a light receiving device and a time-to-digital converter (TDC) of the LiDAR;

FIG. 3 is a diagram showing an example of a histogram memory used for a TOF measurement;

FIGS. 4 and 5 are diagrams showing an example of a 1-step histogram method using the histogram memory of FIG. 3;

FIG. 6 is a diagram showing another example of a histogram memory used for the TOF measurement;

FIG. 7 is a diagram showing an example of a 2-step histogram method using the histogram memory of FIG. 6;

FIG. 8 is a flowchart showing an example of a signal processing method of a light receiving device that may reduce the amount of histogram memory usage, according to an embodiment of the present invention;

FIG. 9 is a diagram showing an example of a memory structure of a signal processing device, according to an embodiment of the present invention;

FIG. 10 is a flowchart illustrating an example of a method for flushing a histogram memory in a candidate memory according to an embodiment of the present invention;

FIG. 11 is a diagram showing timing of determining flush of the histogram memory in the candidate memory, according to an embodiment of the present invention;

FIG. 12 is a diagram illustrating an example of a method for managing information for flushing a histogram memory, according to an embodiment of the present invention;

FIG. 13 is a diagram illustrating an example of a method for periodically determining flushing of a histogram memory, according to an embodiment of the present invention;

FIG. 14 is a diagram illustrating another example of a flush method of a histogram memory, according to an embodiment of the present invention;

FIGS. 15 and 16 are diagrams showing an example of a scanning range of a search memory, according to an embodiment of the present invention;

FIGS. 17 and 18 are diagrams showing an example of a method for reducing a size of the search memory, according to an embodiment of the present invention;

FIG. 19 is a diagram illustrating an example of a method for increasing a detection success rate while reducing a size of a search memory, according to an embodiment of the present invention;

FIG. 20 is a diagram illustrating an example of a method for loading setting values for each pixel using a lookup table, according to an embodiment of the present invention;

FIG. 21 is a diagram illustrating an example of a method for arranging a lookup table, according to an embodiment of the present invention;

FIG. 22 is a diagram illustrating an example of a memory structure for each pixel, according to an embodiment of the present invention;

FIG. 23 is a diagram illustrating another example of a memory structure for each pixel, according to an embodiment of the present invention;

FIG. 24 is a diagram illustrating another example of a memory structure for each pixel, according to an embodiment of the present invention, and

FIG. 25 is a diagram illustrating an example of a method for reconstructing a candidate memory, according to an embodiment of the present invention.

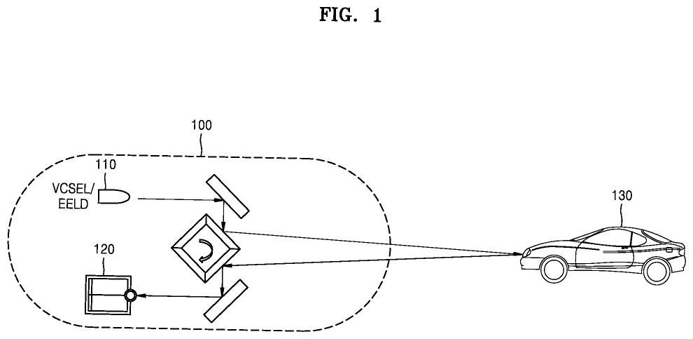

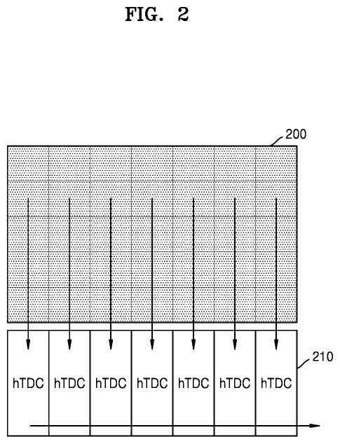

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, a signal processing method and device for a light receiving device according to an embodiment of the present invention are described in detail with reference to the attached drawings.

The signal processing device of this embodiment may be used not only in a LIDAR sensor or an image sensor, but also in various places where a time of flight (TOF) measurement is required, and the field of use thereof is not limited to a specific sensor. However, for convenience of explanation, the following description focuses on the case where the signal processing device is used as a time-to-digital converter (TDC) of the light receiving device of the LiDAR sensor.

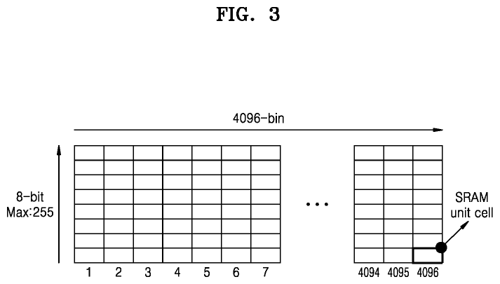

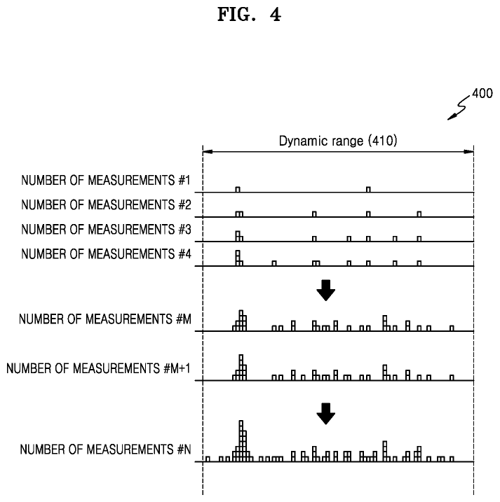

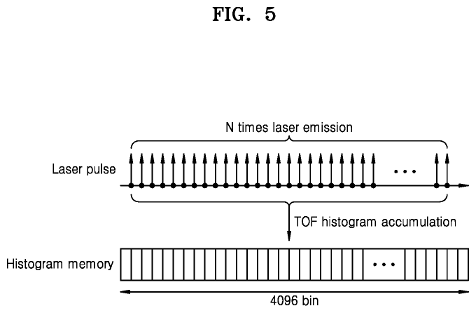

FIG. 3 is a diagram showing an example of a histogram memory used for a TOF measurement, and FIGS. 4 and 5 are diagrams showing an example of a 1-step histogram method using the histogram memory of FIG. 3.

Referring to FIGS. 3 to 5 together, the signal processing device divides the predefined measurement range time (i.e. dynamic range 410) into a plurality of time slots in order to measure the time it takes for the signal (e.g., a laser pulse) output from the light emitting device to be reflected by an object and enter the light receiving device. The example in FIGS. 3 and 5 shows a case where the dynamic range t is divided into 212 (=4096) time slots to implement 12-bit TOF. The dynamic range may be preset to various values depending on the embodiment.

The signal processing device may cumulatively store the number of echo laser receptions for each time slot in the histogram memory in order to determine the number of signal detections in each time slot. At this time, the signal processing device may determine the number of receptions of the echo laser for the reception time slot using the 1-step histogram method 400.

For example, when the first pulse is output from the light emitting device, the signal processing device records in which of the 4,096 time slots the first pulse was detected. When the second pulse is output from the light emitting device, the signal processing device records in which of the 4,096 time slots the second pulse was detected. In this way, the signal processing device sequentially records in which time slot each of the plurality of pulses continuously output from the light emitting device was detected. In other words, as shown in FIG. 5, the LIDAR sensor continuously outputs a plurality of pulses and then determines the TOF by accumulating the number of signal detections in each time slot.

The histogram memory of FIG. 3 includes 4,096 bits corresponding to each time slot on the horizontal axis and 8 bits for accumulating the number of receptions of each echo laser on the vertical axis. Because the range of numbers that may be expressed in 8 bits is 0 to 255 (i.e. 28), the histogram memory may store a total of 256 echo laser reception times. In the histogram memory, the bit string (i.e., vertical bit string) corresponding to each time slot is called a bin. The histogram memory of the present embodiment includes a total of 4,096 bins, as shown in FIG. 5. The histogram memory in FIG. 3 uses a total of 32769 (=8*4,096) bits to cumulatively store the number of receptions of 256 echo lasers.

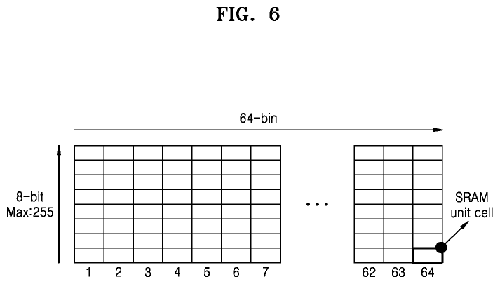

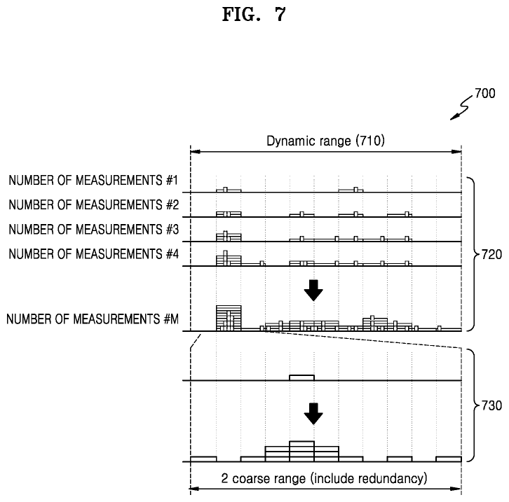

FIG. 6 is a diagram showing another example of a histogram memory used for TOF measurement and FIG. 7 is a diagram showing an example of a 2-step histogram method using the histogram memory of FIG. 6.

Referring to FIGS. 6 and 7 together, the histogram memory includes 64 bits corresponding to 64 time slots on the horizontal axis and 8 bits on the vertical axis to store the cumulative number of receptions of 256 echo lasers. The signal processing device determines the reception time slot of the echo laser using the 2-step histogram method 700.

First, the signal processing device divides the dynamic range 710 into 64 time slots and cumulatively stores the number of echo laser receptions in each time slot 720. For example, the signal processing device accumulates and stores the number of echo laser receptions in each time slot in each bin of the histogram memory.

The signal processing device identities the bin with the maximum accumulated number of receptions based on accumulated number of receptions of the echo laser recorded in the histogram memory. For example, when the accumulated number of bin 6 is the maximum, the signal processing device determines the time slot corresponding to bin 6 as the candidate time slot. Afterwards, the signal processing device divides the candidate time slot (for example, the time slot of bin 6) into 64 detailed time slots and then allocates each detailed time slot to each bin of the histogram memory. The signal processing device stores the number of receptions of the echo laser cumulatively in each bin of the histogram memory corresponding to the detailed time slot (see reference number 730).

In one embodiment, the signal processing device divides the dynamic range into 64 time slots to first determine the reception time slot of the echo laser (see reference number 720), and divides the firstly identified reception time slot (i.e., candidate time slot) into 64 time slots to secondarily determine the reception time slot of the echo laser (see reference number 730). The first identification process 720 and the second identification process 730 are performed using the same histogram memory.

In this case, a total time resolution of 64*64-4,096 is achieved through the first identification process 720 and the second identification process 730, so the signal processing device has the same time resolution as the 12-bit-TOF of FIG. 3. Also, because a total of 512 bits (=64*8) of histogram memory is used to determine the reception time slot of the echo laser, histogram memory usage may be reduced by approximately 98.43% compared to histogram memory of FIG. 3. That is, by changing the 1-step histogram method of FIG. 3 to the 2-step histogram method of FIG. 4, the amount of histogram memory used for TOF measurement may be significantly reduced. Additionally, in order to implement 12-bit TOF, the resolution of the first step and the second step, such as 7-bit/5-bit as well as 6-bit/6-bit 2-step histogram method, may be variously modified depending on the embodiment.

The example of FIG. 7 shows a process of setting a candidate time slot by adding the reception time slot in which the echo laser is received the most times and at least one reception time slot neighboring the reception time slot, then dividing the candidate time slot into 64 time slots to secondarily determine the reception time slot of the echo laser. In addition to this, the number of reception time slots included in the candidate time slot may be modified in various ways depending on the embodiment.

In the 1-step histogram method 400 of FIGS. 4 and 5, when the number of measurements is increased, both the detection success rate (SR) and precision increase. However, the 1-step histogram method 400 has the disadvantage of increasing histogram memory usage. The 2-step histogram method 700 of FIGS. 6 and 7 significantly reduces histogram memory usage compared to the 1-step histogram method 400. However, in the 2-step histogram method 700, increasing the number of measurements in the first identification process 720 only increases the detection success rate, and increasing the number of measurements in the second identification process 730 only increases precision.

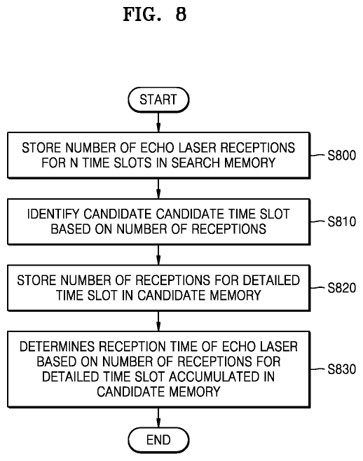

To increase both the detection success rate and precision in the 2-step histogram method 700, the number of measurements in both the first identification process 720 and the second identification process 730 must be increased, but the number of measurements is limited due to frame rate limitations, so the detection success rate and precision are structurally lower than the 1-step histogram method. Therefore, a method that may improve the detection success rate and precision in the 2-step histogram method 700 is needed, which is discussed in detail in FIG. 8 below.

FIG. 8 is a flowchart showing an example of a signal processing method of a light receiving device that may reduce the amount of histogram memory usage, according to an embodiment of the present invention.

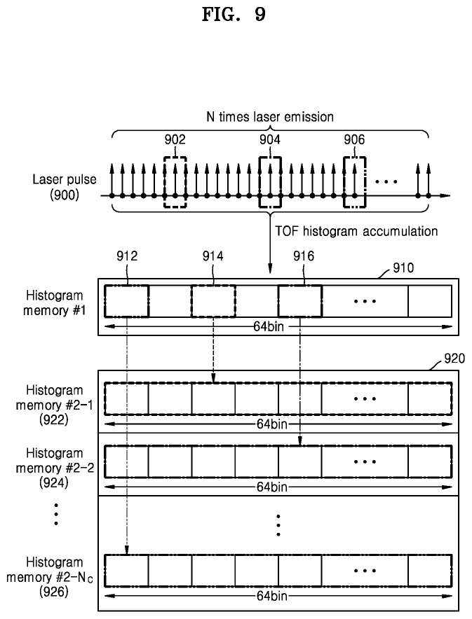

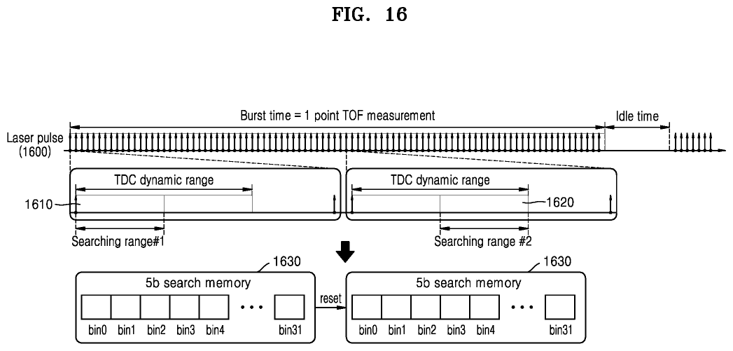

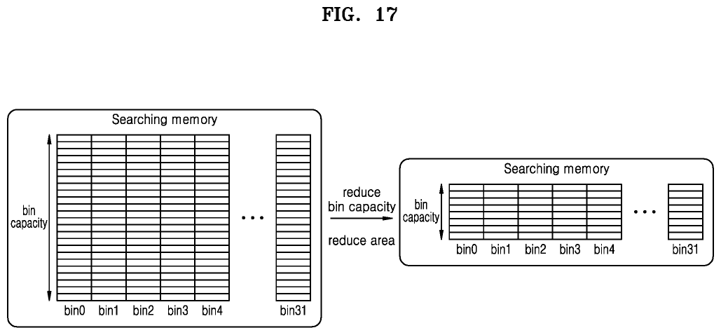

Referring to FIG. 8, in step S800, the signal processing device accumulates and records the number of echo laser receptions for N time slots (N is a natural number of 2 or more) in the search memory. The search memory that accumulates and stores the number of echo laser receptions per time slot may include at least one histogram memory. An example of a search memory consisting of one histogram memory is described in FIG. 9. In another embodiment, in order to reduce the size of the search memory, the scanning range of the histogram memory may be implemented to be smaller than the dynamic range, which is discussed in FIG. 16. In another embodiment, a method of subtracting the accumulated number of receptions in the histogram memory at regular intervals to increase the accumulated number of receptions in the search memory to improve precision is discussed in FIGS. 17 to 19.

In step S810, the signal processing device selects at least one time slot in which the number of receptions reaches a predefined candidate threshold as a candidate time slot. In one embodiment, the candidate time slot may consist of only the reception time slot that has reached the candidate threshold, or may include the time slot that has reached the candidate threshold and at least one neighboring time slot, as seen in FIG. 6. However, hereinafter, for convenience of explanation, it is assumed that the candidate time slot includes only the time slot itself that has reached the candidate threshold. The candidate threshold may be set to various values depending on the embodiment. For example, when the number of bits in each bin of the search memory is 2, the maximum number of receptions that may be stored in each bin is 4 (=22), so the candidate threshold may be set to 4 or less.

The signal processing device divides the candidate time slot into M (M is a natural number of 2 or more) detailed time slots, and cumulatively records the number of echo laser receptions for each detailed time slot in the candidate memory (S820). In one embodiment, the number N of time slots of the search memory may be the same as or different from the number M of detailed time slots of the candidate memory. For example, N and M may be set to N=M=64.

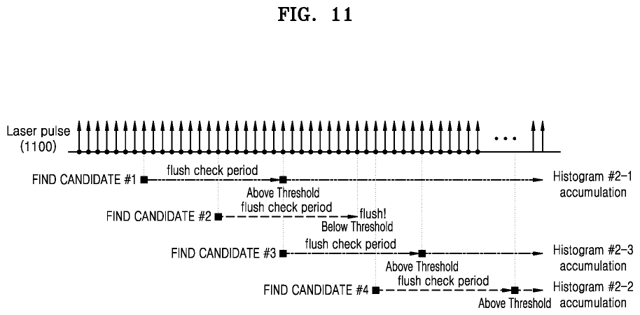

In one embodiment, the candidate memory may include at least one histogram memory. An example of a candidate memory including a plurality of histogram memories for a plurality of candidate time slots is described in FIG. 9. In another embodiment, the candidate memory may be reused by flushing the histogram memory of the candidate time slot that does not meet a certain standard, and this is discussed in FIGS. 11 to 14.

The signal processing device determines the reception time of the echo laser based on the number of receptions for each detailed time slot accumulated in the candidate memory (S830). For example, among the detailed time slots of the plurality of candidate time slots, the detailed time slot with the highest cumulative number of receptions may be identified as the reception time of the echo laser.

To help understand this embodiment, the search memory storage process S800, the candidate time slot identification process S810, and the candidate memory storage process S820 are described in that order, but the search memory storage and candidate time slot identification process S800 and S810 are always performed. That is, when the first candidate time slot is identified, the process of identifying the second candidate time slot is continuously performed.

FIG. 9 is a diagram showing an example of a memory structure of a signal processing device, according to an embodiment of the present invention.

Referring to FIG. 9, the memory of the signal processing device for accumulating and storing the number of echo laser receptions for N time slots largely includes a search memory 910 and a candidate memory 920. The search memory 910 and the candidate memory 920 may be logically separated memories or physically separated memories.

The search memory 910 includes at least one histogram memory. The present embodiment shows a case where the search memory 910 includes one histogram memory. The histogram memory may include a plurality of bins including a plurality of bits. The signal processing device may divide the dynamic range into N time slots and cumulatively store the number of echo laser receptions for each time slot in N bins of the histogram memory. For example, when a series of laser pulses 900 are output from the light emitting device, some of the laser pulses 902, 904, and 906 are reflected by the object and enter the light receiving device, and the signal processing device accumulates and stores the number of echo laser receptions per time slot in each bin 912, 914, and 916 of the search memory. This embodiment is explained based on the bins 912, 914, and 916 corresponding to some time slots. The signal processing device identifies a candidate time slot based on the accumulated number of receptions in each bin 912, 914, and 916 in the search memory 910.

The number of bits of the bins 912, 914, and 916 of the histogram memory constituting the search memory 910 may be set to various values depending on the embodiment. When the number of bits in the bins 912, 914, and 916 is increased, the maximum number of receptions accumulated in each bin 912, 914, and 916 of the search memory 910 increases, thereby increasing the detection success rate, but the size of the search memory 910 also increases. Therefore, considering the size of the search memory 910, the number of bits in each bin 912, 914, and 916 of the histogram memory may be preset to various values depending on the embodiment.

The candidate memory 920 includes at least one histogram memory 922, 924, and 926. This embodiment shows a case where the candidate memory 920 includes a plurality of histogram memories 922, 924, and 926 so that the cumulative number of receptions for a plurality of candidate time slots may be identified.

The histogram memories 922, 924, and 926 in the candidate memory 920 include M bins each corresponding to M detailed time slots. The M detailed time slots divide the candidate time slot into M sections. The number of bits in the bin of the histogram memories 922, 924, and 926 in the candidate memory 920 may be set to various values depending on the embodiment. As the number of bits in the bin increases, the maximum number of receptions accumulated in the candidate memory 920 increases, so precision can be improved, but the size of the candidate memory 920 also increases. Therefore, considering the size and precision of the candidate memory 920, the number of bits in the bin in the candidate memory 920 may be preset to various values depending on the embodiment.

The signal processing device uses the search memory 910 to identify a candidate time slot in which the accumulated number of receptions reaches the candidate threshold. The time slot of the bin 914 of which reception count first reaches the candidate threshold is selected as the first candidate time slot, and the signal processing device allocates the histogram memory 922 of the candidate memory 920 to the first candidate time slot (i.e., the time slot of the bin 914). Then, when the second candidate time slot (i.e., the time slot of the bin 916) is identified in the search memory 910, the signal processing device allocates the histogram memory 924 of the candidate memory 920 to the second candidate time slot. In this way, a plurality of histogram memories 922, 924, and 926 in the candidate memory 920 may be sequentially assigned to each candidate time slot (that is, each time slot of bins 912, 914, and 916).

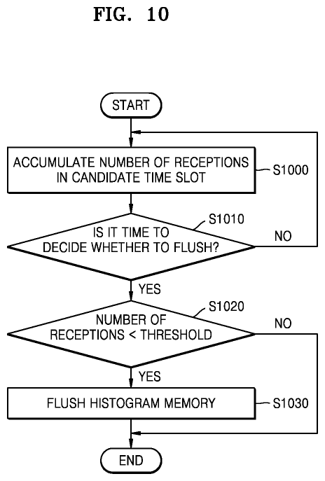

In a case where the number of histogram memories 922, 924, and 926 in the candidate memory 920 is small, when a plurality of candidate time slots are identified by the a plurality of noises, a problem may arise in which the exact reception time of the echo laser cannot be detected. In order to increase the detection success rate, the number of histogram memories 922, 924, and 926 in the candidate memory 920 may be increased, but this case has the disadvantage of increasing the size of the candidate memory 920. As an example of a method to solve this problem, there is a method of allocating the histogram memory 922, 924, and 926 in the candidate memory 920 to the candidate time slots and then flushing and reusing the histogram memory 922, 924, and 926 of the candidate time slots that does not meet a certain condition. This is described again in FIG. 10.

FIG. 10 is a flowchart illustrating an example of a method for flushing a histogram memory in a candidate memory according to an embodiment of the present invention. FIG. 11 is a diagram showing the timing of determining flush of the histogram memory in the candidate memory, according to an embodiment of the present invention.

Referring to FIGS. 10 and 11 together, the signal processing device determines the number of times the echo laser is received during a predefined flush check period for each candidate time slot (S1000). For example, the signal processing device may divide the candidate time slot into M detailed time slots and cumulatively store the number of echo laser reception times for M detailed time slots in each bin of the histogram memory. The signal processing device determines the total number of receptions accumulated during the flush check period (i.e., the total sum of the number of receptions accumulated in M bins) from the time of allocating the histogram memory to the candidate time slot. The flush check period may be set based on the number of outputs of the laser pulse 1100, as shown in FIG. 11.

The signal processing device flushes the histogram memory allocated to the candidate time slot in which the total number of receptions during the flush check period did not reach a predefined flush threshold (S1010, S1020, and S1030). For example, in the example of FIG. 9, when the total number of receptions accumulated in the histogram memory 922 of the first candidate time slot during the flush check period is less than the flush threshold, the value of the histogram memory 922 allocated to the first candidate time slot is initialized so that it may be allocated to another candidate time slot.

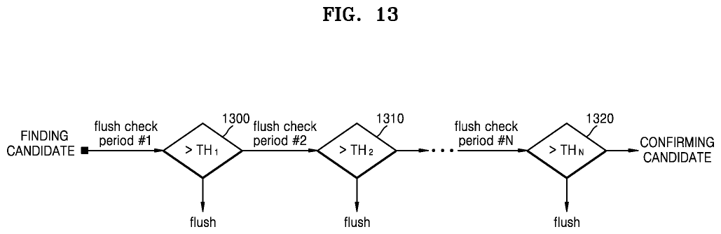

In one embodiment, rather than determining whether to flush once for a candidate time slot, the signal processing device may repeatedly determine whether to flush at regular intervals. An example of this is shown in FIG. 13.

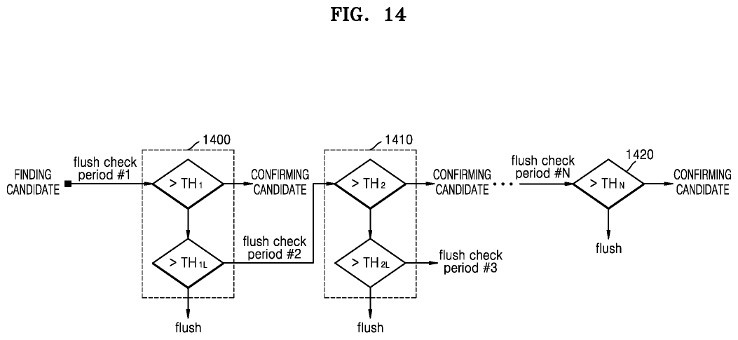

In another embodiment, the signal processing device does not repeatedly determine whether to flush for a plurality of candidate time slots to which the histogram memory is allocated, but may no longer determine whether to flush for candidate time slots that satisfy certain conditions. An example of this is shown in FIG. 14.

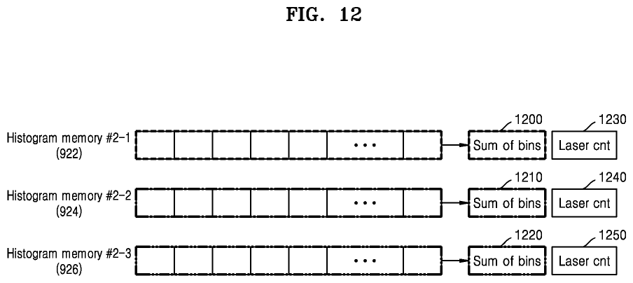

FIG. 12 is a diagram illustrating an example of a method for managing information for flushing a histogram memory, according to an embodiment of the present invention.

Referring to FIG. 12, the signal processing device stores and manages the total number of receptions 1200, 1210, and 1220 and number of lasers 1230, 1240, and 1250 of each histogram memory 922, 924, and 926 in the candidate memory. For example, from the time the first histogram memory 922 is allocated to the first candidate time slot, the signal processing device cumulatively records the number 1200 of echo laser receptions (i.e., the sum of the number of receptions of each bin in the first histogram memory 922) recorded in the first histogram memory 922 and the number 1230 of lasers output from the light emitting device.

For example, when the flush check period is defined as K number of laser outputs, the signal processing device cumulatively records the number of laser pulses output from the light emitting device into the laser count 1230 from the time of allocation of the first histogram memory 922, and when the number of lasers 1230 reaches K, the signal processing device determines whether to flush the first histogram memory 922. This embodiment shows an example of defining a flush check period based on the number of laser pulses output from the light emitting device, but this is just one example, and various values representing a certain time period may be used as the flush check period.

FIG. 13 is a diagram illustrating an example of a method for periodically determining flushing of a histogram memory, according to an embodiment of the present invention.

Referring to FIG. 13, the signal processing device periodically determines whether to flush each histogram memory. For example, when the flush check period for the first histogram memory 922 elapses, the signal processing device determines whether to flush the first histogram memory 922 using the method shown in FIG. 10 (see reference number 1300). When the first histogram memory 922 has not been flushed at the time of the first determination, the signal processing device determines whether to perform a second flush of the first histogram memory 922 when the flush check period elapses (see reference number 1310). In this way, the signal processing device may determine whether to flush the first histogram memory in N cycles (see reference number 1320).

In one embodiment, the flush threshold for determining whether to flush may be the same value or different values for each cycle. For example, the first flush threshold for determining flushing in the flush check period of the first cycle and the second flush threshold for determining flushing in the flush check period of the second cycle may be set to different values.

By reducing the size of the flush check period and periodically determining whether to flush the histogram memory several times based on the accumulated number of receptions, noise may be quickly removed through a low flush threshold, thereby reducing the time that noise occupies the histogram memory.

FIG. 14 is a diagram illustrating another example of flush method of a histogram memory, according to an embodiment of the present invention.

Referring to FIG. 14, the signal processing device periodically determines whether to flush the histogram memory, as shown in FIG. 13. The signal processing device uses the upper and lower thresholds when determining whether to flush (see reference numbers 1400 and 1410).

For example, when the total number of receptions accumulated in the first histogram memory 922 is greater than the upper threshold, the signal processing device no longer performs the process of determining whether to flush the first histogram memory 922. That is, the candidate time slot of the first histogram memory 922 is confirmed as a candidate and is not discarded from the candidate memory.

When the total number of receptions accumulated in the first histogram memory 922 is less than the lower threshold, the signal processing device flushes the first histogram memory 922. That is, the candidate time slot of the first histogram memory 922 is excluded from the candidates for determining the reception time slot of the echo laser. When the total number of receptions of the first histogram memory 922 is less than the upper threshold and greater than the lower threshold, the signal processing device determines whether to flush the first histogram memory 922 again in the next cycle. In one embodiment, at the end of the flush determination cycle, the signal processing device may determine whether to flush using only the upper threshold (see reference number 1420).

The amount of computation may be reduced because flushing is no longer determined for candidate time slots that exceed the upper threshold based on the upper and lower thresholds. That is, according to this embodiment, in the case of a high-intensity signal, the flush check is not necessarily repeated, and candidate time slots that are judged to be noise due to a small number of receptions may be quickly flushed, thereby increasing the rotation rate of the candidate memory and improving overall logic efficiency.

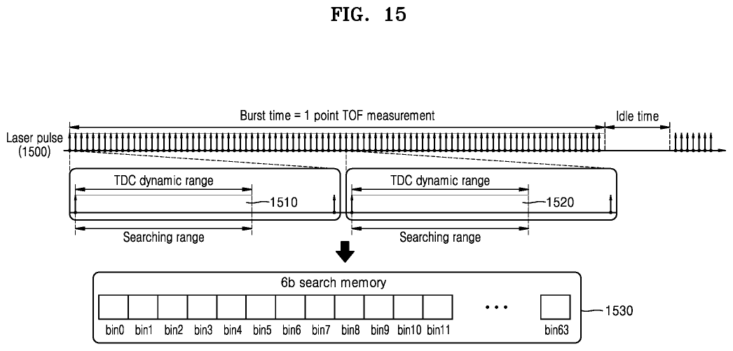

FIGS. 15 and 16 are diagrams showing an example of a scanning range of a search memory, according to an embodiment of the present invention.

Referring to FIG. 15, in order to measure the TOF of 1 point, the signal processing device may scan a plurality of laser pulses output from the light emitting device (i.e., a plurality of laser pulses within the burst time) in a dynamic range and cumulatively record the number of times the echo laser has been received in the search memory 1530. That is, the scanning range 1510 and 1520 of the search memory 1530 matches the dynamic range. For example, in order to search for candidate time slots, the signal processing device may divide the dynamic ranges 1510 and 1520 into 64 time slots and may cumulatively record the cumulative number of times for each time slot in 64 bins of the search memory 1530.

Referring to FIG. 16, the signal processing device divides the dynamic range into at least two scan ranges 1610 and 1620, and cumulatively records the number of receptions of echo lasers scanned in the scan ranges 1610 and 1620 in the search memory 1630. For example, when dividing the dynamic range into two scan ranges 1610 and 1620, the signal processing device scans the first scan range 1610 to identify the number of receptions of the echo laser for the laser pulse output in the first half of the burst time among the laser pulses 1600 output from the light emitting device and cumulatively store the number of receptions of the echo laser in the search memory 1630. After resetting the search memory 1630, the number of receptions of the echo laser for the laser pulse output in the second half of the burst time is scanned in the second scan range 1620 and stored cumulatively in the search memory 1630.

Because the scan ranges 1610 and 1620 of the search memory 1630 of FIG. 16 are half of the scan ranges 1500 and 1510 of the search memory 1530 of FIG. 15, the number of bins may be half that of FIG. 15 while maintaining the same resolution as that of FIG. 15. That is, the embodiment of FIG. 16 may reduce the size of the search memory 1530 by half compared to the embodiment of FIG. 15.

This embodiment shows an example of dividing the dynamic range into two equally sized scan ranges 1610 and 1620, but this is only an example, and the number of scan ranges 1610 and 1620 that divide the dynamic range and the size of each scan range 1610 and 1620 may vary depending on the embodiment. For example, because the intensity of the echo laser returning from a close distance is greater than the intensity of the echo laser returning from a long distance, the scan range 1610 of the first half may be made less than the scan range 1620 of the second half. Depending on the size of the scan range 1620, the number of bins and the number of bits of the histogram memory may be dynamically changed. In another embodiment, the number of laser pulses scanning in the first half scan range 1610 and the number of laser pulses scanning in the second half scan range 1620 may be the same or different from each other. In another embodiment, the laser pulse output in the first half of the burst time may be scanned in the second half scan range 1620, and the laser pulse output in the second half of the burst time may be scanned in the first half scan range 1610.

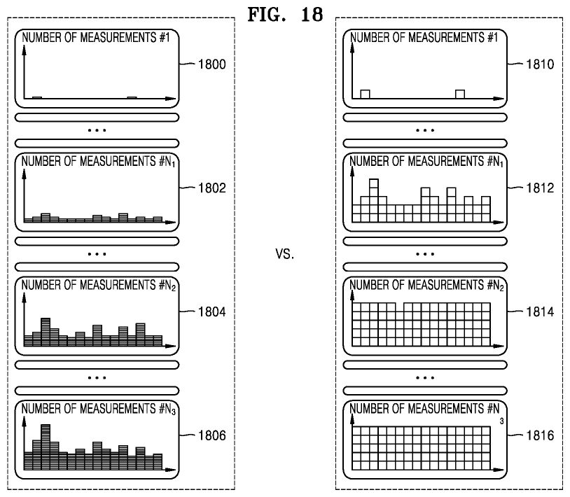

FIGS. 17 and 18 are diagrams showing an example of a method for reducing the size of the search memory, according to an embodiment of the present invention.

Referring to FIGS. 17 and 18, the size of the search memory may be reduced by reducing the number of bits allocated to the bins of the histogram memory that constitutes the search memory. The left picture of FIG. 18 shows the process of identifying the histogram of the number of receptions based on the search memory on the left of FIG. 17, and the picture on the right of FIG. 18 shows the process of identifying a histogram of the number of receptions based on the search memory on the right of FIG. 17. When the number of bits in a bin is reduced to reduce the size of the search memory, the maximum number of receptions that may be recorded in each bin is reduced, thereby lowering the detection success rate. Looking at the left graph 1800, 1802, 1804, and 1806 of FIG. 18, each bin is not saturated even if the number of measurements increases, but looking at the graph 1810, 1812, 1804, and 1806 on the right side of FIG. 18, when the number of measurements exceeds a certain level, many bins are all saturated, making it difficult to determine at what time slot the echo laser was received.

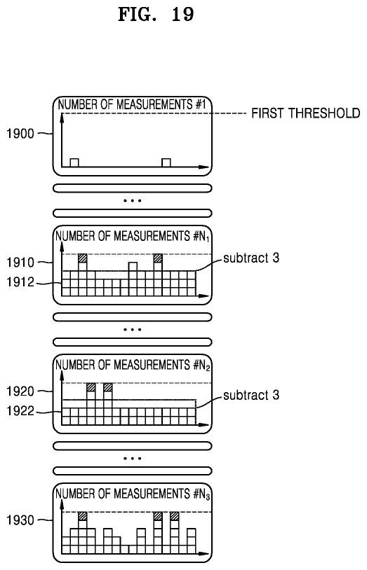

FIG. 19 is a diagram illustrating an example of a method for increasing the detection success rate while reducing the size of the search memory, according to an embodiment of the present invention.

Referring to FIG. 19, the signal processing device may increase the detection success rate by subtracting the number of receptions accumulated in the search memory by a predefined value (hereinafter, subtraction value) at regular intervals (hereinafter, subtraction period). For example, after accumulating and recording the number of receptions of the echo laser over a certain period of time in the histogram memory (see reference number 1900), the subtraction value (for example, 3) may be subtracted from the number of receptions 1912 and 1922 of each bin at each subtraction cycle (see reference numbers 1910 and 1920). The signal processing device may initialize the bin to 0 when the cumulative number of receptions for each bin is less than the subtraction value. The signal processing device repeatedly performs the process of subtracting the subtraction value for each subtraction cycle and then determines the reception time slot of the echo laser based on the final cumulative reception count (see reference number 1930).

The candidate threshold, subtraction period, and subtraction value may be adjusted to various values depending on the purpose. For example, by lowering the candidate threshold, candidate time slots may be found quickly. However, when there is a lot of noise, there is a disadvantage that the number of histogram memories in the candidate memory must be great. In environments with less noise, the candidate threshold may be lowered.

As another example, in an environment with a lot of noise, increasing the subtraction value helps remove noise, but has the disadvantage that in environments where the signal strength (i.e., the reception strength of the echo laser) is low, signals other than noise are also eliminated. Therefore, after finding the minimum intensity of the signal (i.e. echo laser) reflected at the maximum distance to be measured, the candidate threshold may be made as small as possible depending on the intensity of the noise at the time of operation, and the subtraction period and subtraction value may be adjusted to appropriate values.

In another embodiment, when using the partial scan ranges 1610 and 1620 observed in FIG. 16, because the intensity of the signal being scanned in each scan range 1610 and 1620 may be different, the candidate threshold, subtraction period, and subtraction value for each scan range 1610 and 1620 may be set, respectively.

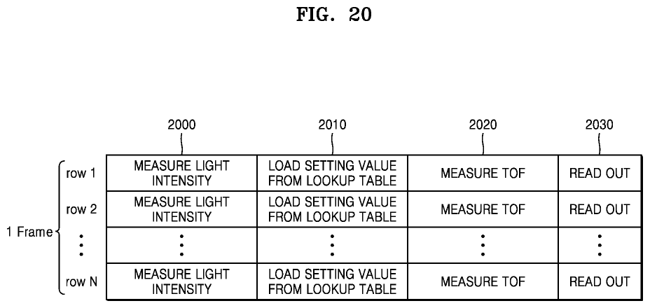

FIG. 20 is a diagram illustrating an example of a method for loading setting values for each pixel using a lookup table, according to an embodiment of the present invention.

Referring to FIG. 20, the signal processing device may manage setting values for optimal operation for each pixel by storing the setting values in a lookup table. The lookup table may store and manage various setting values by mapping them with light intensity. For example, in an environment with strong external light (i.e., background light), the size of the candidate threshold may be increased, the subtraction period may be shortened, and the subtraction value may be increased so that noise may be reliably removed even if the signal returning from a long distance may not be identified. As another example, in an environment with weak external light, the candidate threshold may be lowered to quickly find a candidate time slot, and precision may be improved by increasing the maximum accumulated number of candidate time slots in the candidate memory, similar to the 1-step histogram method.

To do this, the signal processing device first measures the background light intensity of each pixel (see reference number 2000) and loads the setting value corresponding to the background light intensity from the lookup table (see reference number 2010). Then, the signal processing device measures TOF (see reference number 2020) and reads out the TOF (see reference number 2030). The setting values loaded from the lookup table may include a candidate threshold for selecting a candidate time slot shown in FIGS. 7 and 8, a flush threshold for determining whether to flush a shown in FIGS. 10 to 15, the partial scan range shown in FIG. 16, and the subtraction period and subtraction value shown in FIG. 17. The background light intensity of each pixel may be determined by measuring external light from the light-receiving device without laser output from the light-emitting device.

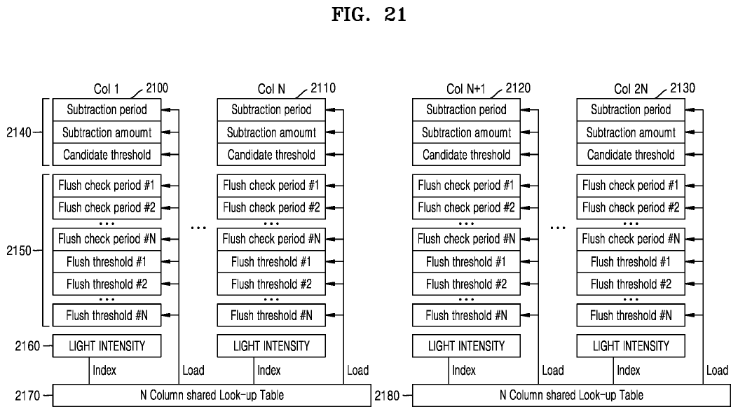

FIG. 21 is a diagram illustrating an example of a method for arranging a lookup table, according to an embodiment of the present invention.

Referring to FIG. 21, the signal processing device may include a plurality of lookup tables 2170 and 2180. The lookup tables 2170 and 2810 store various light intensities and mapped settings. When the light receiving device processes the echo laser on a row basis, lookup tables 2170 and 2180 may be provided for each of the plurality of columns 2100, 2110, 2120, and 2130. This embodiment presents a case in which two lookup tables 2170 and 2180 are provided.

The signal processing device first determines the light intensity 2160 (i.e., background light intensity) of each pixel, then refers to the lookup tables 2170 and 2180 using the light intensity 2160 and loads the setting value for each pixel. For example, the signal processing device may load the search memory setting value 2140 and the candidate memory setting value 2150 from the lookup tables 2170 and 2180 and then perform the method of FIGS. 7 to 19 for the corresponding pixel.

This embodiment shows two lookup tables 2170 and 2180, but this is only an example and the lookup tables 2170 and 2180 may be implemented as one or three or more. Alternatively, lookup tables 2170 and 2180 may be provided for each column 2100, 2110, 2120, and 2130. As the number of lookup tables 2170 and 2180 increases, the time required to index and load each column 2100, 2110, 2120, and 2130 may be reduced, but the area of the lookup tables 2170 and 2180 increases. Therefore, an appropriate number of lookup tables 2170 and 2180 may be implemented depending on the embodiment, considering loading time and area, etc.

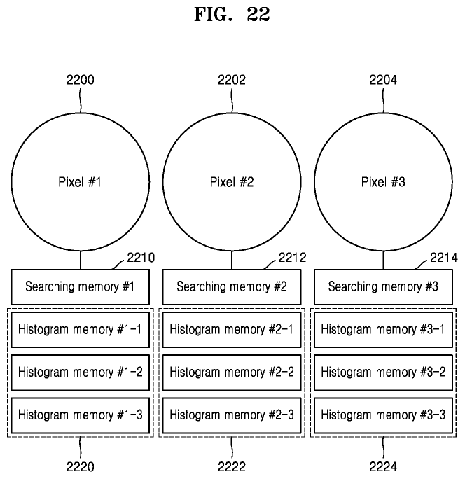

FIG. 22 is a diagram illustrating an example of a memory structure for each pixel, according to an embodiment of the present invention.

Referring to FIG. 22, each pixel 2200, 2202, and 2204 is provided with a search memory 2210, 2212, and 2214 and a candidate memory 2220, 2222, and 2224. A signal processing device may be provided for each pixel. That is, the signal processing device of each pixel uses search memories 2210, 2212, and 2214 and candidate memories 2220, 2222, and 2224 to determine the reception time slot of the echo laser.

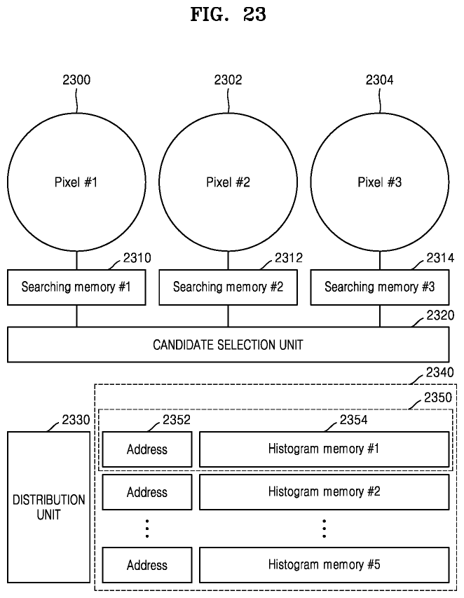

When considering performance, the greater the number of histogram memories in the candidate memory, the better, but it has the disadvantage of increasing the area of the candidate memory. Excluding noise accumulating in the candidate memory, only one histogram memory is required per pixel. However, because there is noise, a plurality of histogram memories are needed in the candidate memory. The size of the candidate memory may be reduced, but the candidate memory may be shared to reduce performance degradation due to noise. This is described again in FIG. 23.

This embodiment shows three pixels 2200, 2202, and 2204 for convenience of explanation, but this is only an example and the number of pixels constituting the sensor array may vary depending on the embodiment. However, for convenience of explanation, the following embodiments, including the present embodiment, are described based on three pixels 2200, 2202, and 2204.

FIG. 23 is a diagram illustrating another example of a memory structure for each pixel, according to an embodiment of the present invention.

Referring to FIG. 23, the signal processing device uses a candidate memory 2340 that integrates the histogram memories of a plurality of pixels 2300, 2302, and 2304. The number of detected candidate time slots for each pixel 2300, 2302, and 2304 may be different. For example, one candidate time slot may be searched for in the first pixel 2300, and five candidate time slots may be searched for in the second pixel. When the number of histogram memories in the candidate memories 2220, 2222, and 2224 of each pixel is three, the histogram memories of the candidate memory 2200 is surplus in the first pixel 2300 and the histogram memories of the candidate memory is insufficient in the second pixel 2302.

Accordingly, in this embodiment, the histogram memories of a plurality of pixels 2300, 2302, and 2304 are integrated and used. Because candidate memories are shared between adjacent pixels, the number of histogram memories in the candidate memory per pixel may be reduced, thereby reducing the area of the signal processing device. However, address information 2352 is needed to distinguish which pixel the candidate time slot recorded in the candidate memory is.

Looking more specifically, the signal processing device performs a process of searching for candidate time slots using the search memories 2310, 2312, and 2314 of each pixel 2300, 2302, and 2304 through a candidate selection unit 2320, respectively. In other words, the process of identifying candidate time slots for each pixel is performed independently. When the candidate selection unit 2320 searches for a candidate time slot in one of the plurality of pixels 2300, 2302, and 2304, a distribution unit 2330 allocates the histogram memory 2354 in the integrated candidate memory 2340 to the candidate time slot. At this time, address information 2352 is also stored to distinguish which pixel the candidate time slot was searched for. Because the search memory 2310, 2312, and 2314 corresponds 1:1 to the pixels 2300, 2302, and 2304, the address information of the search memory (for example, the address of the starting location of the search memory, etc.) may be stored in the address information 2352.

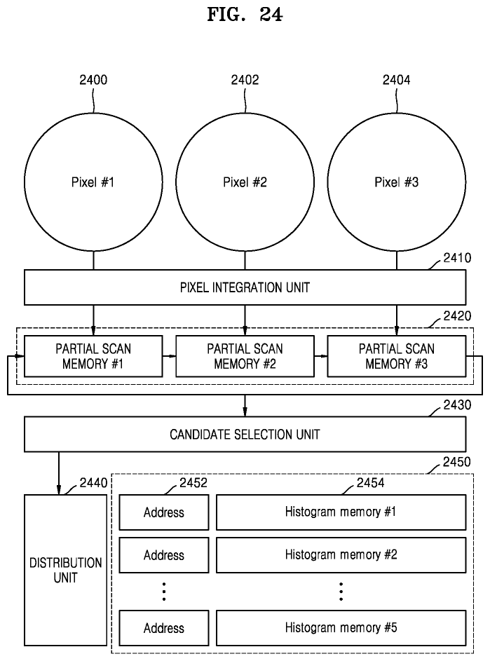

FIG. 24 is a diagram illustrating another example of a memory structure for each pixel, according to an embodiment of the present invention.

Referring to FIG. 24, the signal processing device integrates and uses search memory of a plurality of pixels 2400, 2402, and 2404 and candidate memory of a plurality of pixels. For example, the search memory of each pixel may be a histogram memory (hereinafter referred to as partial scan memory) that scans a part of the dynamic range observed in FIG. 16. The example of the scanning range of the search memory shown in FIG. 16 has the advantage of reducing the size of the search memory. However, in the example shown in FIG. 16, the number of receptions of the echo laser is not accumulated during the burst time of one cycle, but only a part of the dynamic range is scanned in the first half of the burst time to accumulate the number of receptions of the echo laser, and then the search memory is reset, and the remainder of the dynamic range is scanned again in the second half of the burst time to accumulate the number of echo laser receptions. Therefore, because the maximum value of the accumulated number of echo laser receptions in each scan range is small, there may be cases where sufficient data to improve precision may not be secured.

To solve this problem, a plurality of pixels 2400, 2402, and 2404 are merged and a search memory 2420 that integrates the partial scan memory of each pixel 2400, 2402, and 2404 is used. In the case where there are three pixels 2400, 2402, and 2404 as in this embodiment, the partial scan memory of each pixel may be a memory that scans a scan range that divides the dynamic range into three equal portions. By using the scan range of all three pixels 2400, 2402, and 2404 integratedly, the entire dynamic range may be scanned at once. The pixel integration unit 2410 integrates the three pixels 2400, 2402, and 2404 to determine whether the echo laser is received to cumulatively record the number of receptions per time slot in the integrated search memory 2420. The configuration of the candidate selection unit 2430, the distribution unit 2440, the integrated candidate memory 2450 including the address information 2452 and the histogram memory 2454 is the same as the configuration shown in FIG. 23, so further description thereof is omitted. Depending on the environment in which the signal processing device is used, the signal processing device may be used by integrating only the candidate memory as shown in FIG. 23 or may be used by integrating both the search memory and the candidate memory as shown in FIG. 24.

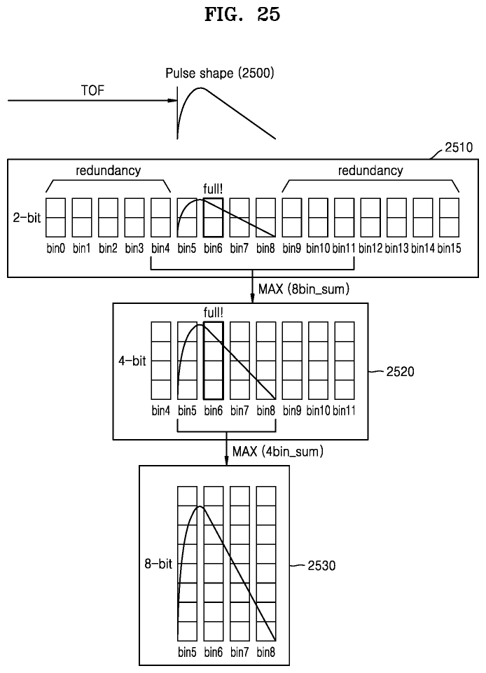

FIG. 25 is a diagram illustrating an example of a method for reconstructing a candidate memory, according to an embodiment of the present invention.

Referring to FIG. 25, the signal processing device may dynamically adjust the number of bins in the candidate memory and the number of bits in each bin. For example, the signal processing device may configure the histogram memory in the candidate memory as a first structure 2510 including 16 2-bit bins. Because the interval (i.e., resolution) of the candidate time slot is greater than the pulse width 2500 of the echo laser, it is not possible to know exactly at which point in the candidate time slot the echo laser exists. Therefore, the entire candidate time slot is divided into detailed time slots, and the reception point of the echo laser is first determined through the histogram memory of the first structure 2510, which includes a plurality of bins corresponding to each detailed time slot.

When there is a bin in the histogram memory of the first structure 2510 whose accumulation count reaches a predefined first reconstruction threshold (for example, 22 in the case of a 2-bit bin), the signal processing device transforms the histogram memory of the first structure 2510 into a second structure 2520 including 8 bins of 4 bits. For example, in the first structure 2510, the signal processing device leaves a certain number of bins on both sides of the bin (example, bin 6) that has reached the first reconstruction threshold, then removes the redundancy bins and allocates the bits of the removed bins to the remaining bins. That is, the total number of bits of the histogram memory is the same, but as it is transformed from the first structure 2510 to the second structure 2520, the maximum number of receptions that may be accumulated and recorded in each bin increases.

When a bin (e.g., bin 6) occurs in the second structure 2520 whose cumulative number of receptions reaches a second reconstruction threshold (e.g., 24 for a 4-bit bin), the signal processing device leaves a certain number of bins surrounding the bin that reaches the second reconstruction threshold in the histogram memory of the second structure 2520, removes the rest, and then transforms the histogram memory into a third structure 2530 in which the number of bits of the remaining bins is increased. Through this process, the cumulative number of receptions of echo lasers present in the candidate time slot may be increased to accurately distinguish whether the echo laser in the candidate time slot is noise or a real signal.

This embodiment shows an example of performing two transformation processes from the first structure 2510 to the third structure 2530, but this is only one example and the number of transformation processes may be varied depending on the embodiment. In addition, the number of bins left in the histogram memory of each structure 2510, 2520, 2530 centered on the bin that has reached the reconstruction threshold may be varied in various ways depending on the embodiment.

The present invention may also be implemented as computer-readable program code on a computer-readable recording medium. Computer-readable recording media include all types of recording devices that store data that may be read by a computer system. Examples of computer-readable recording media include ROM, RAM, CD-ROM, magnetic tape, floppy disk, and optical data storage devices. Additionally, computer-readable recording media may be distributed across networked computer systems so that computer-readable code may be stored and executed in a distributed manner.

According to an embodiment of the present invention, the amount of histogram memory used for TOF measurement may be reduced. Because the amount of histogram memory used is small, TDC may be implemented with a small memory size. In addition, the resolution of the light receiving device may be improved by reducing the size of the pixel and TDC of the light receiving device. Additionally, the size of histogram memory may be reduced with little performance degradation.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A signal processing method for a light receiving device, the signal processing method comprising:
cumulatively recording, in a search memory, a number of echo laser reception times for N time slots (N is a natural number of 2 or more);
selecting at least one time slot in which the number of echo laser receptions reaches a candidate threshold as a candidate time slot;
dividing the candidate time slot into M detailed time slots (M is a natural number of 2 or more) and cumulatively recording, in a candidate memory, the number of echo laser receptions for each detailed time slot; and
determining a reception time of an echo laser based on the number of echo laser receptions for each detailed time slot accumulated in the candidate memory.

2. The signal processing method of claim 1,
wherein the candidate memory includes a plurality of histogram memories on which the number of echo laser receptions for the candidate time slot is recorded,
the cumulative recording of the number of echo laser receptions in the candidate memory includes:
allocating histogram memories to the candidate time slots in an order in which the number of echo laser receptions reaches the candidate threshold; and
cumulatively recording, in an allocated histogram memory, the number of echo laser receptions for a plurality of detailed time slots within the candidate time slot;

3. The signal processing method of claim 1, further comprising flushing the histogram memory allocated to the candidate time slot in which the number of echo laser receptions does not reach a flush threshold during a predefined flush check period.

4. The signal processing method of claim 3, further comprising allocating the flushed histogram memory to a new candidate time slot identified from the search memory.

5. The signal processing method of claim 3,
wherein the flush check period is defined based on a number of output times of a laser pulse.

6. The signal processing method of claim 3, further comprising repeatedly performing the flushing of the histogram memory at regular intervals.

7. The signal processing method of claim 6, wherein the repeatedly performing the flush at regular intervals includes
terminating the repeatedly performing the flush for candidate time slot in which the number of echo laser receptions exceeds an upper threshold; and
flushing the histogram memory allocated to the candidate time slot when the number of echo laser receptions is less than a lower threshold.

8. The signal processing method of claim 1, the cumulative recording of a number of echo laser reception times in the search memory includes:
dividing a dynamic range for a time of flight (TOF) measurement into a plurality of scan ranges; and
performing a process of recording the number of echo laser reception times for each scan range in the search memory for each of the plurality of scan ranges.

9. The signal processing method of claim 8, wherein the numbers of times the echo laser respectively scans in at least two or more scan ranges among the plurality of scan ranges are different from each other.

10. The signal processing method of claim 1,
wherein the cumulative recording of a number of the echo laser reception times in the search memory includes cumulatively storing the number of echo laser receptions for N (N is a natural number) time slots in a histogram memory including N bins, and the signal processing method further comprising subtracting a predefined subtraction value at each predefined subtraction period from the accumulated number of receptions for time slots stored in the N bins.

11. The signal processing method of claim 1, further comprising,
when a lookup table is provided to store candidate thresholds each mapped to a plurality of different light intensities,
identifying the candidate threshold corresponding to an intensity of background light measured by the light receiving device using the lookup table.

12. The signal processing method of claim 1, wherein the search memory is provided for each pixel, the candidate memory is common to a plurality of pixels.

13. The signal processing method of claim 12, the cumulative recording in the candidate memory includes storing the number of echo laser reception times in the candidate memory along with address information of the pixel in which the candidate time slot is found.

14. The signal processing method of claim 1,
wherein the search memory is configured by integrating partial scan memories existing in a plurality of pixels, and
the cumulative recording of the number of echo laser reception times in the search memory includes merging the plurality of pixels to determine the number of times the echo laser has been received.

15. The signal processing method of claim 1, wherein the cumulative recording in the candidate memory includes:
storing the number of times the echo laser has been received in a histogram memory including a plurality of bins including a plurality of bits; and
reconstructing the histogram memory by leaving a certain number of bins centered on a bin corresponding to a detailed time slot in which the number of receptions in the histogram memory reaches a predefined reconstruction threshold and removing the redundancy bins, and then allocating bits of the removed bins to the remaining bins.

16. A signal processing device for a light receiving device, the signal processing device comprising:
a search memory whereon a number of echo laser receptions is cumulatively recorded for N (N is a natural number of 2 or more) time slots; and
a candidate memory whereon a number of receptions of the echo laser for at least one time slot in which the number of receptions corresponds to a predefined candidate threshold is cumulatively recorded,
wherein the search memory and the candidate memory each include a histogram memory including a plurality of bins including a plurality of bits.

17. The signal processing device of claim 16, wherein the candidate memory includes a plurality of histogram memories for allocation to a plurality of candidate time slots.

18. The signal processing device of claim 16, wherein the search memory includes a histogram memory whereon the number of receptions of the echo laser in a scan range smaller than a dynamic range for time of flight (TOF) measurements is cumulatively stored.

19. The signal processing device of claim 16, further comprising a lookup table that stores the optimal candidate thresholds mapped to light intensities,
wherein the candidate threshold is determined by referring to the lookup table based on the intensity of background light of the light receiving device.

20. The signal processing device of claim 19, wherein the lookup table is provided for each row or column in a pixel array.

21. The signal processing device of claim 16, wherein the candidate memory is common to a plurality of pixels.

22. The signal processing device of claim 16,
wherein the search memory is configured by integrating partial scan memories provided to a plurality of pixels, and
the number of echo laser receptions determined by merging the plurality of pixels is recorded in the search memory.

23. The signal processing device of claim 16, wherein the number of bins and the number of bits of each bin in the histogram memory of the candidate memory are dynamically changed.
